(19) United States
(12) Patent Application Publication
(10) Pub. No.: US 2016/0129844 A1
(43) Pub. Date: May 12, 2016

(54) Walkway System

(71) Applicant: ACCESS INNOVATIONS PTY LTD, Kingaroy, Queensland (AU)

(72) Inventor: Michael William Magnussen, Kingaroy (AU)

(21) Appl. No.: 14/901,029

(22) PCT Filed: Jun. 30, 2014
(86) PCT No.: PCT/AU2014/000677

§ 371 Date: Dec. 27, 2015

(30) Foreign Application Priority Data
Jun. 28, 2013 (AU) 2013902486

(51) Int. Cl. B60R 3/00; B60R 21/13

(52) U.S. Cl. CPC B60R 3/005; B60R 21/131

(57) ABSTRACT

A walkway mount system comprising at least one walkway section; and at least one walkway mount, each mount including a mounting body that is able to be located between an upper portion and a lower portion of a roll over protection system of a vehicle; and at least one arm that is attached to the mounting body and is able to be attached to and support the at least one walkway section.

### FIELD OF THE INVENTION

This invention relates to a walkway system. In particular, the invention relates to a walkway system that is able to be used to mount a walkway around the cabin of a bulldozer. However, it should be appreciated that the walkway system may be used on other types of vehicles that have a roll over protection system,

### BACKGROUND OF THE INVENTION

The presence of a walkway mounted around the cabin of a bulldozer is common place. The walkway allows an operator access to the cabin, provides the ability to clean the glass of the cabin and also enables an operator to view any obstacles located close the side and/or the rear of the bulldozer that would otherwise not be visible from the cabin. Also maintenance personnel can access and perform tasks on window wipers, lights, reversing alarms, rear cameras, radio and GPS aerials and receivers mounted on and around the cabin.

Most walkways are mounted to a bulldozer by welding the walkway to the bulldozer. This often involves welding walkway mounting brackets to a fuel tank that is located at the rear of the bulldozer. The brackets are then connected to the walkway. This process is very time consuming and requires skilled labor.

There are other associated problems with welding the brackets to the fuel tank to install the walkway. During installation of brackets on the fuel tank it is necessary to open the vents located on the fuel tank. If the vents are not opened, the internal gas located within the fuel tank will become heated causing the gas to expand. This will usually cause the tank to buckle and/or break. A buckled or broken tank is required to be replaced which is both expensive and time consuming.

A further issue with welding brackets to the fuel tank is that welding changes the structural integrity of the tank by making it more briftle. Movement of the walkway, by people walking over the walkway or by normal use of the vehicle, applies force through the brackets to the tank. This will normally cause the tank to split prematurely. Again, the tank is required to be replaced which is both expensive and time consuming.

The reference to any prior art in this specification is not, and should not be taken as an acknowledgement or any form of suggestion that the prior art forms part of the common general knowledge.

### OBJECT OF THE INVENTION

It is an object of the invention to overcome and/or alleviate one or more of the above disadvantages and/or provide the consumer with a useful or commercial choice,

### SUMMARY OF THE INVENTION

In one form, although not necessarily the only or broadest form, the invention resides a walkway mount system comprising:

at least one walkway section; and
at least one walkway mount, each mount including:

a mounting body that is able to be located between an upper portion and a lower portion of a roll over protection system of a vehicle; and

at least one arm that is attached to the mounting body and is able to be attached to and support the at least one walkway section.

Normally there are at least two walkway mounts. Preferably, there are two walkway mounts.

The mounting body of a walkway mount is normally in the form of a mounting plate. The body may have one or more holes that end through the body. The holes may be for location of fastener. The fastener is normally in the form of a bolt.

Normally there may be one or two arms attached to the mounting body. Each arm is normally welded to the mounting body. Each arm may extend outwardly from the mounting body. Each arm may be formed from rectangular hollow section. However, it would be appreciated by a person skilled in the art that each arm may be made from other sections such as L-shaped, U-shaped, circular, Further, it would be appreciated that the arm may not be hollow but may be solid.

Each arm may have walkway attachment tabs located on the arm for attaching the walkway section to the arm. Each arm may be removably attached to an associated walkway section.

There normally is more than one walkway section. Each walkway section may include a base. The base may be attached to at least one arm. At least one handrail may be attached to the base. One walkway section may be attached to another walkway section.

In another form, the invention resides in walkway mount for mounting a walkway section, the walkway mount comprising:

a mounting body that is able to be located between an upper portion and a lower portion of a roll over protection system of a vehicle; and

at least one arm that is attached to the mounting body and is able to be attached to and support the at least one walkway section.

In yet another form, the invention resides in a vehicle including:

a roll over protection system; having an upper portion and a lower portion;
at least one walkway section; and
at least one walkway mount, each walkway mount including:

a mounting body that is located between an upper portion and a lower portion of the roll over protection system of a vehicle; and

at least one arm that is attached to the mounting body and is able to be attached to and support the at least one walkway section,

The vehicle is typically in the form of a bulldozer. However, the vehicle may be any vehicle that has a roll over protection system.

upper portion of the roll over protection system may be in the form of a roll over cage. The roll over cage may be substantially U-shaped.

The lower portion of the roll over protection system may be in the form one or more brackets. Each bracket may be used to attach the upper portion of the roll over protection system to the vehicle. Accordingly the one or more brackets may be integrally formed with the vehicle.

In another form, the invention resides in a method of installing a walkway system onto a vehicle that has a roll over protection system, the method including the steps of:

securing a mounting body of walkway mount between an upper portion and a lower portion of the roll over protection system; and

attaching a walkway section to at least one arm that is extends outwardly from the mounting body.

Further forms and features of the present invention will become apparent from the following detailed description.

### BRIEF DESCRIPTION OF THE DRAWINGS

An embodiment, by way of example only, will now be described with reference to the accompanying drawings in which:

FIG. 1 is a view perspective of a bulldozer including a walkway system according to an embodiment of the invention;

FIG. 2 is a further view perspective of a bulldozer including a walkway system according to FIG. 1;

FIG. 3A is an exploded view perspective of a bulldozer including a walkway system according to FIG. 1;

FIG. 3B is an detailed exploded view perspective of a bulldozer including a walkway system according to FIG. 3A;

FIG. 4A is an exploded view perspective of a bulldozer including a walkway system according to FIG. 1;

FIG. 48 is an detailed exploded view perspective of a bulldozer including a walkway system according to FIG. 4A

FIG. 5 is a perspective view of a first walkway mount according to an embodiment of the invention;

FIG. 6A is a perspective view of a second walkway mount according to an embodiment of the invention;

FIG. 6B is a further perspective view of a second walkway mount according to FIG. 5A;

FIG. 7 is a perspective view of a first walkway section according to an embodiment of the invention;

FIG. 8A is a perspective view of a second walkway section according to an embodiment of the invention;

FIG. 8B is a perspective view of a second walkway section according to FIG. 8A;

FIG. 9A is a perspective view of a third walkway section according to an embodiment of the invention;

FIG. 9B is a perspective view of a third walkway section according to FIG. 9A; and

FIG. 98 is a perspective view of a third walkway section according to FIG. 9C.

### DETAILED DESCRIPTION OF THE PREFERRED EMBODIMENT

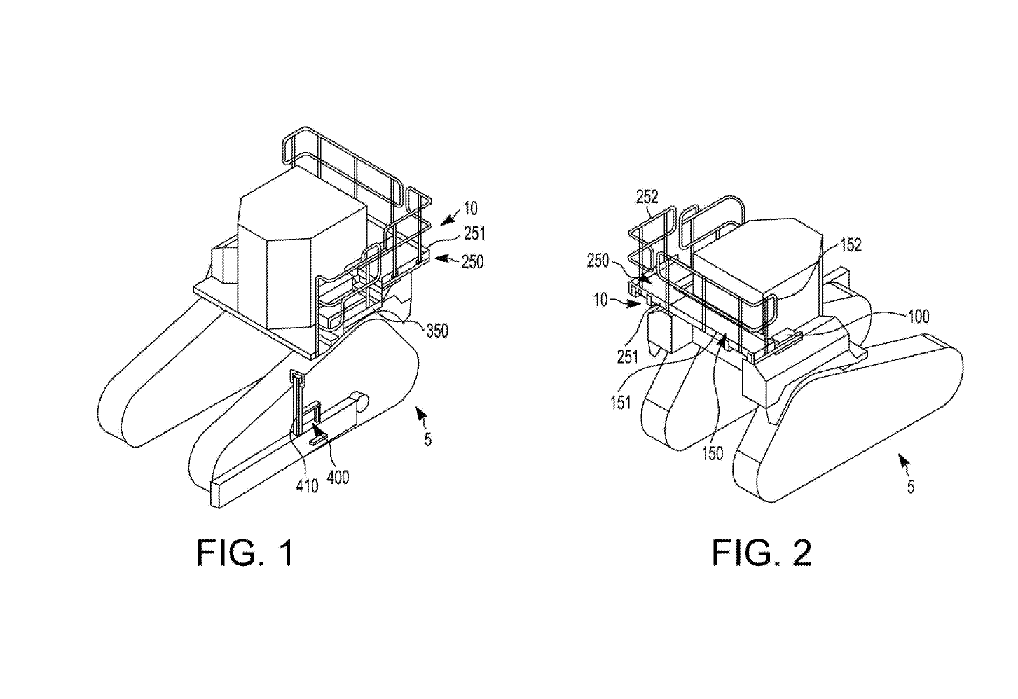

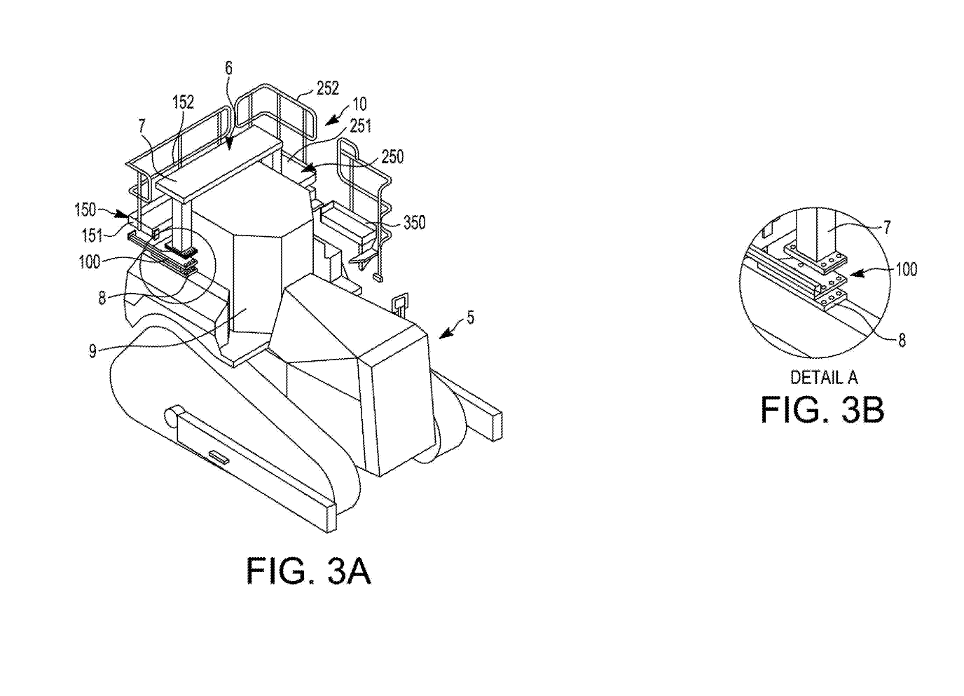

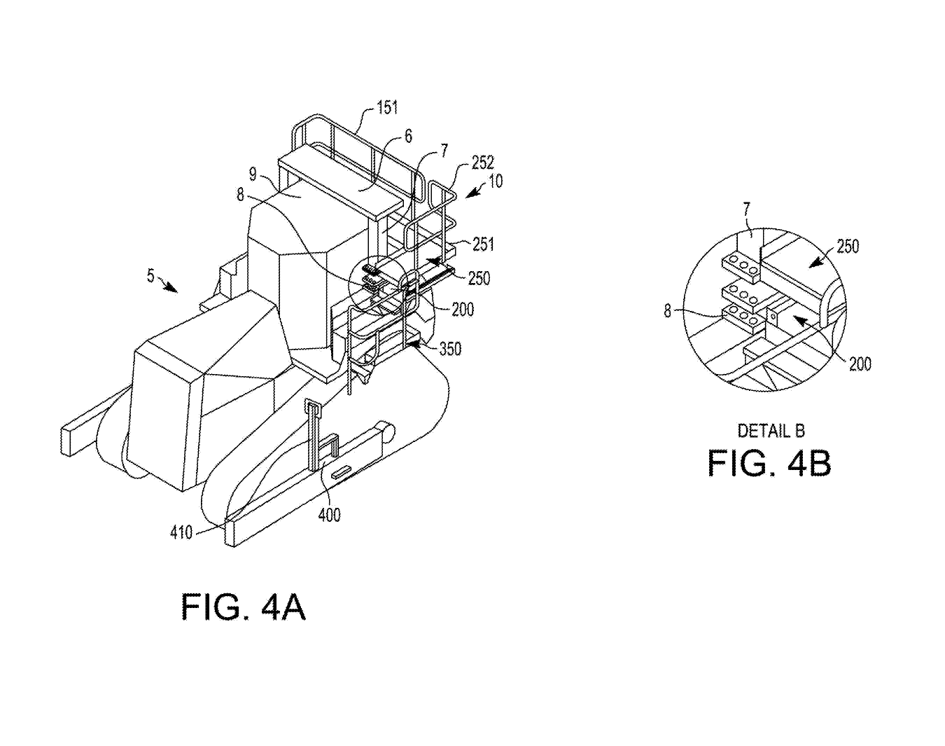

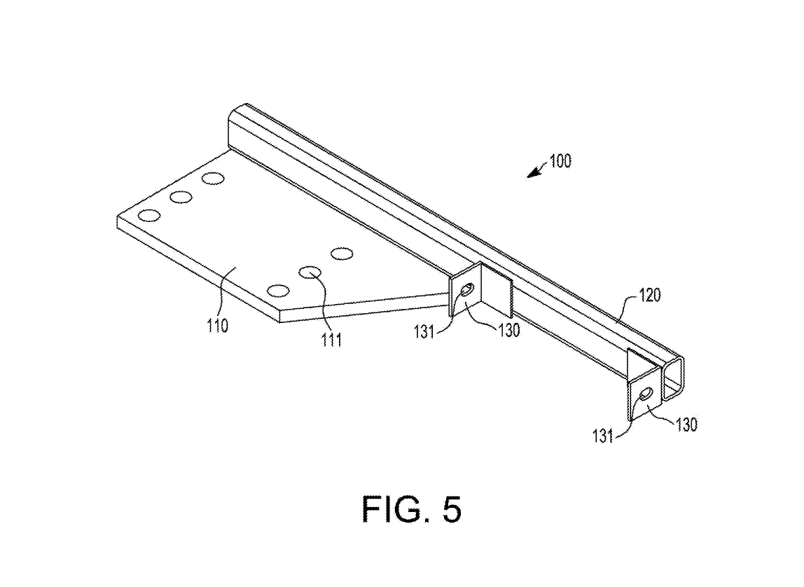

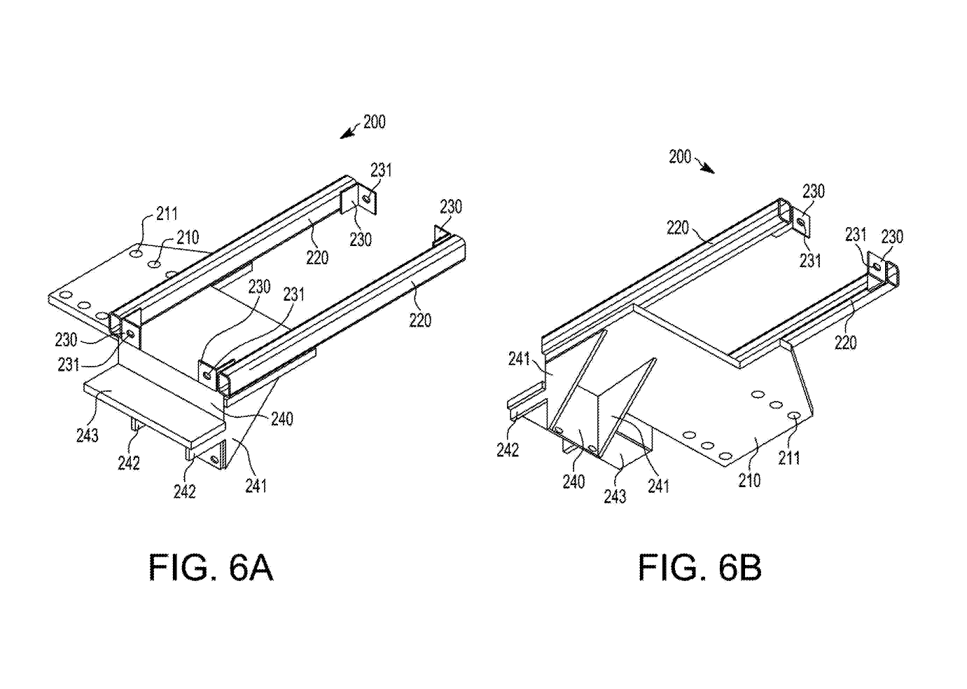

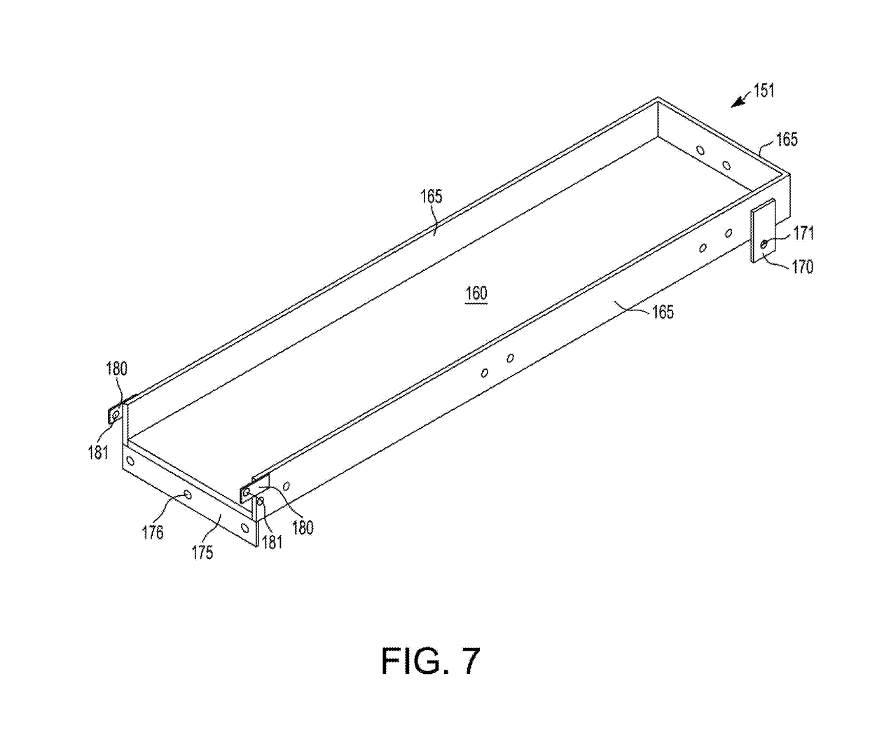

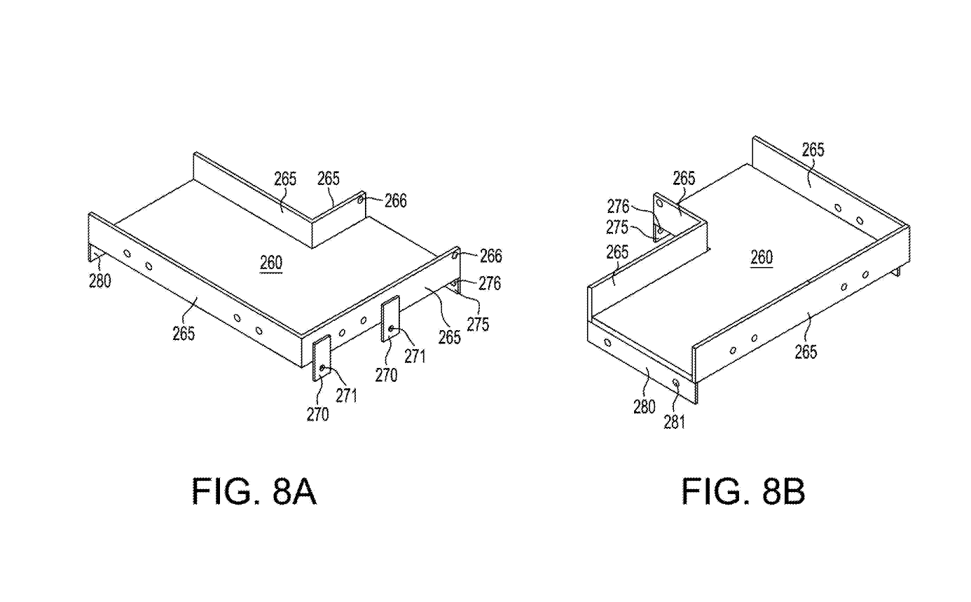

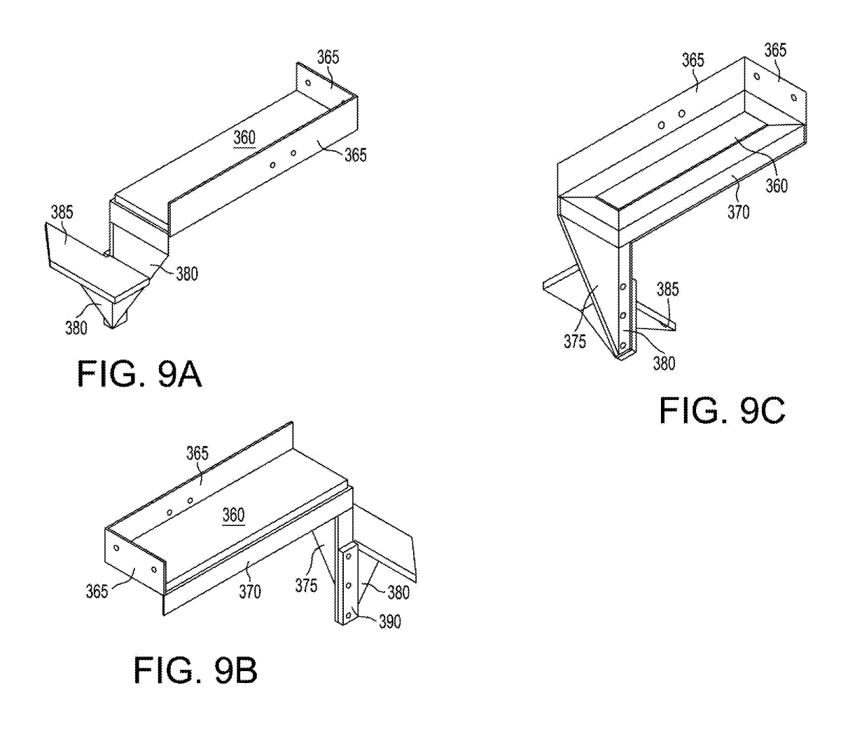

FIGS. 1 and 2 show a bulldozer 5 to which is attached a walkway system 10. The walkway system 10 is attached to the bulldozer 5 using a roll over protection system 6, shown in FIG. 3A and 4A which forms part of the bulldozer 5. The roll over protection system 6 includes an upper U-shaped portion 7 and two brackets 8 which are attached to a body of the bulldozer 5. In normal use the upper U-shaped portion 7 is attached to the brackets 8 using bolts (not shown) so that the upper U-shaped portion 7 protects a user with a cabin in the event that the bulldozer 5 rolls over.

The walkway system 10 includes two walkway mounts 100 and 200 that are used to mount two walkway sections 150 and 250. The first walkway mount 100, shown in greater detail in FIG. 3A, 33 and 5, is formed from a mounting plate 110 to which is welded an arm 120. The mounting plate 110 has a series of mounting holes 111 located through the mounting plate 110. The mounting holes are of the same configuration as holes located in the upper portion 7 and bracket 8 of the left hand side of the roll over protection system 6 of the bulldozer 5. The arm 120 is constructed from rectangular hollow section and is welded to the mounting plate 110. Two walkway attachment tabs 130 are located on the arm. The walkway attachment tabs 130 are made from angle iron and are spaced apart. A walkway attachment hole 131 is located through each of the walkway attachment tabs.

The second walkway mount 200, shown in more detail in FIG. 4A, 4B, GA and 6B, is formed from a mounting plate 210 to which is welded two arms 220. The mounting plate 210 has a series of mounting holes 211 located through the mounting plate 210. The mounting holes 211 are of the same configuration as holes located in the upper portion 7 and bracket 8 of the right hand side of the roil over protection system 6 of the bulldozer 5. Each of the arms 220 is made from rectangular hollow section and is welded to the mounting plate 210. Walkway attachment tabs 230 are located at ends of each of the arms 220. The arms 220 are made from angle iron and are welded to the arms 220. Walkway attachment holes 231 extend through each of the walkway attachment tabs 230. A face plate 240 Is welded to and extends downwardly from the bottom of the mounting plate 210. Two stair webs 241 are welded to the face plate 240 and the mounting plate 210. Each of the stair webs 241 includes an outwardly extending projection 242. These projections 241 are used to mount a stair tread 243 which is welded to the projections and the face plate 240.

The first walkway section 150 includes a base 151 and a handrail 152. The base 151 of the walkway section 150 is shown in more detail in FIG. 7. The base 151 includes a floor plate 160 which is substantially rectangular in shape. A series of kick plates 165 are attached to the floor plate by welding. Arm attachment tabs 170 extended downwardly from the kick plates 165. Arm attachment holes 171 extend through the arm attachment tabs 170. A walkway abutment plate 175 is located at one end of the floor plate 160 and extends downwardly with respect to the floor plate 160. Abutment holes 176 are located through the walkway abutment plate 175. Kick plate attachment tabs 180 are located the kick plates 165 and extend outwardly from the kick plates 165. Kick plates 165 attachment holes 180 are located through the kick plate attachment tabs 180.

The second walkway section 250 again includes a base 251 and handrail 252. The base 251 shown in more detail in FIG. 8A and 8B includes an L-shaped floor plate 260, A series of kick plates 265 extend upwardly from the floor plate and are welded to the floor plate 260. Kick plate attachment holes 266 are located end kick plates 265. A walkway abutment plate 275 is located at one end of the floor plate 260 and extends downwardly with respect to the floor plate 260. Abutment holes 276 are located through the walkway abutment plate. An arm attachment plate 280 is located at the other end of the floor plate 260 and also extends downwardly from the floor plate 260. Arm attachment holes 281 are located through the arm attachment plate 281. Arm attachment tabs 270 extend downwardly from one of the kick plates 265. Arm attachment holes 271 are located through the arm attachment tabs 270.

In order to install the walkway system 10, the roil over protection system 5 must first be dismantled. This involves removing bolts (not shown) from the upper U-shaped portion 7 that are fastened to the brackets 8. Once the bolts have been removed, the upper U-shaped portion 7 can be removed from the brackets 8. Once the U-shaped upper portion has been removed, the two walkway mounts 100, 200 are located over the brackets 8 so that the mount holes 111, 211 located through the respective mounting plates 110, 210 are in alignment with holes in the respective brackets 8. The upper U-shaped portion 7 is then lowered onto the mounting plates 110, 210 of the walkway mounts 100, 200 so that the holes located within the upper portions are in alignment with the mount holes 111, 211 in the mounting plates 110, 210 of the walkway mounts 100, 200. Longer bolts (not shown) are then fed through the holes located in the upper portion 7 and mounting holes 111, 211 in the mounting plates 110, 210. The bolts (not shown) are then tightened so that they screw into the brackets 8 to sandwich the mounting plates 110, 210 between the upper U-shaped portion 7 and the brackets 8.

Once the two walkway mounts 100, 200 are in place, then the walkway sections 150, 250 can be attached to the walkway mounts 100, 200. The second walkway section 250 is mounted to the second mount 200 before the first walkway section 110 is mounted to the first walkway mount 100.

The second walkway mount 200 is mounted to the second walkway section 250 by placing the walkway section 250 over the arms 220 of the second walkway mount 200. The second walkway section 250 is then moved until the arm attachment tabs 270 and arm attachment plate 280 is aligned with the walkway attachment tabs 230 on the respective arms 220, Bolts (not shown) are then located through the arm attachment holes 231 in the arm attachment tabs 230, the arm attachment holes 281 in the arm attachment plate 281 and through the walkway attachment holes 231 in the walkway attachment tabs 230. Nuts (not shown) are then located over the bolts to fasten the second walkway to the arms 220 of the second mount 200.

The first walkway section 100 is then located over the arm 110 of the first attachment mount 100. The first walkway section 100 is moved so that abutment holes 176, 276 in the walkway plates 175, 275 of the first walkway section 100 and the second walkway section 250 are in alignment. Bolts (not shown) are then located through the walkway abutment holes 176, 276 and fastened together using associated nuts not shown). The kick plate attachment holes 181 in the kick plate attachment tabs 181 and kick plate attachment holes 266 in the kick plates 265 will also be aligned and fastener together using nuts and bolts (not shown).

The walkway attachment tabs 130 on the arms 110 are then aligned with the arm attachment tabs 170 on the first walkway section 150. Bolts (not shown) are then located through the walkway attachment holes 131 in the walkway attachment tabs 130 and the arm attachment holes 171 in the arm attachment tabs 170. The walkway attachment tabs 170 and the arm attachment tabs 170 are then fastened together using associated nuts and respective bolts (not shown).

It should be appreciated that the hand rails 152, 252 may be pre-attached to the base 151, 251 before they are attached to the walkway mounts 100, 200 or the hand rails may be attached to the base after the base is mounted to the walkway mounts 100, 200.

It should be appreciated that other elements may be added to the walkway system for practical purposes. For example additional walkways sections may be added. FIG. 9A, 9B and 9C show a third walkway section 350 which is welded to a body of the bulldozer 5 and also fastened to the second walkway mount 200. The third walkway section includes a floor plate 360 and two kick plates 365 which extend upwardly from the floor plate 360. A weld plate 370 extends downwardly from one side of the floor plate 360 and is welded to the floor plate 260. A web 375 is welded to the front of the floor plate 360. A stair plate 380 is welded to a side of the floor plate 360 and to the web 375 and is used to support a stair tread 385. The stair tread 385 is welded to the front of the web 375 and stair plates 380.

In order to install the third walkway section 350, the weld plate 370 is welded to the body of the bulldozer 5. An additional weld plate 390 is welded onto the stair plate 380 and also welded to the bulldozer 5. The kick plate 365 is aligned with the stair plate 240 on the second walkway mount 250 and bolted to the second walkway mount 250 using associated bolts and nuts (not shown).

It should also be appreciated that another feature that may be added is a step 400 located on the beam connects the body of the bulldozer 5 to the blade. This step 400 may be of any configuration but typically includes a hand holder 410 as shown on FIGS. 1 and 4A.

In this specification, the terms “comprise”, “comprises”, “comprising” or similar terms are intended to mean a non-exclusive inclusion, such that a system, method or apparatus that comprises a list of elements does not include those elements solely, but may well include other elements not listed.

It should be appreciated that various other changes modifications may be made to the embodiment described with that departed from the spiritual scope of the invention.

1. A walkway mount system comprising:
at least one walkway section; and
at least one walkway mount, each mount including:
a mounting body that is able to be sandwiched between an upper portion and a lower portion of a roll over protection system of a vehicle; and
at least one arm that is attached to the mounting body and is able to be attached to and support the at least one walkway section.

2. The walkway mount system of claim 1 including at least two walkway mounts.

3. (canceled)

4. The walkway mount system of claim 2 wherein the mounting body of a walkway mount is in the form of a mounting plate.

5. The walkway mount system of claim 4 wherein the body has one or more holes that end through the body.

6. The walkway mount system of claim 5 wherein the holes are for the location of fastener.

7. The walkway mount system of claim 6 wherein the fastener is in the form of a bolt.

8. The walkway mount system of claim 2 wherein there is one or two arms attached to the mounting body.

9. The walkway mount system of claim 8 wherein each arm is welded to the mounting body.

10. The walkway mount system of claim 8 wherein each arm extends outwardly from the mounting body.

11. The walkway mount system of claim 8 wherein each arm is formed from rectangular hollow section.

12. The walkway mount system of claim 8 wherein each arm has walkway attachment tabs located on the arm for attaching the walkway section to the arm.

13. The walkway mount system of claim 8 wherein each arm is removably attached to an associated walkway section.

14. The walkway mount system of claim 1 wherein there is more than one walkway section.

15. The walkway mount system of claim 1 wherein each walkway section includes a base.

16. The walkway mount system of claim 8 wherein the base is attached to at least one arm.

17. (canceled)

18. (canceled)

19. (canceled)

20. A vehicle including:
a roll over protection system; having an upper portion and a lower portion;
at least one walkway section; and
at least one walkway mount, each walkway mount including:
a mounting body that is sandwiched between an upper portion and a lower portion of the roll over protection system of a vehicle; and
at least one arm that is attached to the mounting body and is able to be attached to and support the at least one walkway section.

21. The vehicle of claim 20 wherein the vehicle has a roll over protection system.

22. The vehicle of claim 21 wherein the upper portion of the roll over protection system is in the form of a roll over cage.

23.

24. The vehicle of claim 21 wherein the lower portion of the roll over protection system is in the form one or more brackets.

25. (canceled)

26. (canceled)

27. A method of installing a walkway system onto a vehicle that has a roll over protection system, the method including the steps of:
sandwiching a mounting body of walkway mount between an upper portion and a lower portion of the roll over protection system; and
attaching a walkway section to at least one arm that is extends outwardly from the mounting body.
